(19) United States
(12) Patent Application Publication
(10) Pub. No.: US 2002/0169646 A1
(43) Pub. Date: Nov. 14, 2002

(54) Planning and administrating a manufacturing plant

(76) Inventor: James Casserly, Routio (FI)

Correspondence Address: YOUNG & THOMPSON, 745 SOUTH 23RD STREET 2ND FLOOR, ARLINGTON, VA, 22202

(21) Appl. No.: 10/125,355

(22) Filed: Apr. 19, 2002

Related U.S. Application Data
(63) Continuation of application No. PCT/FI00/00903, filed on Oct. 18, 2000.

(30) Foreign Application Priority Data
Oct. 19, 1999 (FI) 19992256

(51) Int. Cl. G06F 17/60

(52) U.S. Cl. 705/7

(57) ABSTRACT

A method for planning and administrating the use of resources in a manufacturing process comprising a plurality of activities. The method comprises the steps of: 1) representing manufacturing activities as operations; 2) classifying manufacturing activities as either planned or active; receiving material- or activity-related information; 3) creating an operation list (O) comprising operations, based on the material- or activity-related information; 4) representing active manufacturing activities as operation groups; 5) creating the operation groups by grouping operations in the operation list (O) when activities are to be changed from planned to active state; 6) representing tangible or intangible properties which are modified by manufacturing activities as resources, wherein the modifying comprises use, creation, change and/or deletion of a resource by the corresponding activity; and 7) quantifying the modifying by associating resource data with operations.

This application is a Continuation of International Application PCT/FI00/00903 filed on Oct. 18, 2000, which designated the U.S. and was published under PCT Article 21(2) in English.

### BACKGROUND OF THE INVENTION

The invention relates to methods and equipment for planning and administrating the material and manufacturing capacity requirements for a manufacturing company.

A general problem when manufacturing a product is to ensure that the materials required for the manufacturing process are procured on time in the correct quantities, and that there exists sufficient capacity in terms of personnel and machinery for processing the materials into a finished product.

Much work has been made since the 1960's to develop computer systems for the purpose of planning and operating such manufacturing activities. A general term applied to these software programs is MRP, which stands for Material Requirements Planning or, alternatively, Manufacture Requirements Planning. An MRP system attempts to model the manufacturing activities of a company by a software system. Such systems are in wide use, and have been developed to run on many kinds of computer platforms from mainframes to personal computers in both single-user and multi-user environments.

Manufacturing steps can be classified as being either ‘process’ or ‘discrete’. Process manufacturing is based on the continuous flows of materials (such as in an oil refinery) and will not be further discussed in this document. In a discrete manufacturing system, goods are manufactured as batches of one or more substantially identical goods. The systems that plan the materials and resources in this kind of manufacturing make use of the concept of a batch.

Prior art discrete manufacturing systems can be described as being order and inventory based, and these principles are described in detail for instance in the handbook of APICS (American Production and Inventory Control Society, Inc.). They employ the principle of moving materials into and out of inventory on according to ‘orders’. Materials and other items are recorded in data tables in a database, and software code is used to generate a user interface and a logic for handling and analysing the data. For example, a purchase order is written to procure materials, and based on the purchase order, a goods-inward activity may be made in the system. This goods-inward activity will create a log entry that materials have arrived in the manufacturing facility, and by reference to the information on the purchase order, the inventory values are adjusted. Similarly, sales orders record goods that are being sold by the company. Sales order information is used to create dispatch lists which in turn are used as the basis for removing stock from inventory. Work orders are used to handle the information concerning one batch. A key element of the work order is the product structure. This is the information of what materials are needed to manufacture one item of the batch. For instance, the product structure of a knife may be a handle, one piece; a blade, one piece and a sheath, one piece. A batch of 50 knives would need 50 of each component to manufacture the batch. The MRP system in its simplest form would be concerned with planning that the correct quantities of each component are present at the start of the manufacture of the batch.

A specific problem associated with the prior art is the complexity in implementing a planning system for these different types of orders. In particular, maintaining multiple sets of data structures, such as one for sales orders, one for purchasing orders and one for manufacturing work orders, brings an unnecessary level of complexity in system design. These structures do not easily lend themselves to such real-life situations as buying services from a subcontractor, which is part of both a purchase order structure and a work order structure. Special cases have to made, which again raises the complexity of the system design. Another typical problem is the division inside a work order between material, labour and machine. It is common to define the materials belonging to a product as a ‘product structure’, with an associated set of data tables, and the labour and machine facilities belonging to a product as a ‘product routing’, with its own, separate data structure. This brings the problem of how to handle unusual features of a manufacturing process. For example, a product might need a ‘pollution emissions permit’. This permit may need to be purchased like a material, but it is valid only for a certain time and it cannot be kept in stock.

### BRIEF SUMMARY OF THE INVENTION

An object of the invention is to provide a mechanism for planning the use of resources in a batch manufacturing system that is more flexible than the prior art mechanisms. This object is achieved with a method and equipment that are characterised by what is disclosed in the attached independent claims. Preferred embodiments of the invention are disclosed in the attached dependent claims.

The invention is partially based on discovering a problem in a resource-planning system which is used and taught extensively. The invention is also based on finding a solution for the problem.

In the following description, an ‘operation’ refers to an activity or process that occurs in a manufacturing environment. An operation is related to a specified operation template. An operation is linked also to a demand element from which it has been created. This demand element may be within the scope of the operation/resource/template model described in this application, or may be outside it. An example of the former is a resource consumption of another operation. Examples of the latter are a sales order line item, a purchase order line item or a line of a sales forecast.

An ‘operation template’ is a model for an operation. The operation template describes procedures, properties and resources for execution of the operation that it models. Values of some of the data of the template may not be complete, but may be completed only after a specific operation has been created from the template. The template is not linked to a demand element. An operation template has a reference to the main single resource that is created or removed when an operation based on the template is executed. Although an operation may create or remove a multiplicity of resources in the manufacturing environment, the user must select a single resource to be the main resource.

An operation or operation template will also have related property and/or procedure and/or resource information.

An ‘operation group’ (also referred to as a ‘group’) refers to a collection of operations which are related to the same operation template and one-to-one other linking piece of information called the ‘relates to’ field. The type of information contained in the relates to field will be determined by an attribute of the operation template. Operation groups will also be created from operations that are scheduled to occur in a certain, user-specified time frame, but this is not an essential feature. A group may be defined even if it consists of a single operation.

A ‘resource’ refers to any object tangible or intangible that may be consumed or generated in the manufacturing environment in the course of the execution of an operations group. Some examples of resources are materials, a component used in an assembly, the assembly itself, machinery, personnel, subcontract services, physical space, energy, and government permits. Preferably, each object, person or service is described as a resource. It is also useful to be able to attribute properties to a resource. For instance a person may have an e-mail address and a machine may have a manufacturer's name. Each resource has a reference to the name of the operation template that creates it and/or removes it from the manufacturing environment. An example of creating resource is receiving purchased goods from a supplier or a product created as a result of a manufacturing activity. Examples of removing a resource from the manufacturing environment include consumption of a raw material, consumption of energy, processing of a part (where the old part is consumed and a new part is created) and shipping of a product to a customer.

A method according to the invention can be implemented as follows.

1. Different types of manufacturing activities are modelled as operation templates;

2. planned manufacturing activities are represented as operations which are not yet members of a group;

3. operations are created manually or automatically in an operation list according to information obtained from an organisation's administrative system (for example sales order or purchase order handling systems) or from other information from the organisation's manufacturing system (for example by referring to calculations of future material shortages);

4. active manufacturing activities (in common practice often referred to as ‘open work orders’) are represented as operation groups, which are created by grouping operations in the operation list when activities should be moved from a planning stage to an active stage; and

5 materials, machinery, personnel and other tangible and intangible property used or created in the manufacturing environment are represented as resources, and the creation and removal of resources in the manufacturing environment is quantified by associating resource data with operations.

A method according to a preferred embodiment of the invention comprises the steps of:

1. maintaining a list of operation templates;

2. maintaining a list of resources;

3. generating a list of operations according to rules based in software systems both external and internal to the manufacturing system;

4. grouping together operations and their related information to present and process a manufacturing activity according to procedures and properties that the group of operations has inherited from the common operation template to which the operations in the group belong.

### BRIEF DESCRIPTION OF THE DRAWINGS

A method and an apparatus according to the invention will be described more in detail by means of a preferred embodiment with reference to the appended drawing in which:

FIG. 1 illustrates a typical computer network topology;

FIG. 2, which consists of sub-FIGS. 2A to 2C, illustrates the various data structures according to the invention;

FIG. 3A illustrates the steps for creating operations from operation templates; and

FIG. 3B illustrates the steps for creating operation groups from operations.

### DETAILED DESCRIPTION OF THE INVENTION

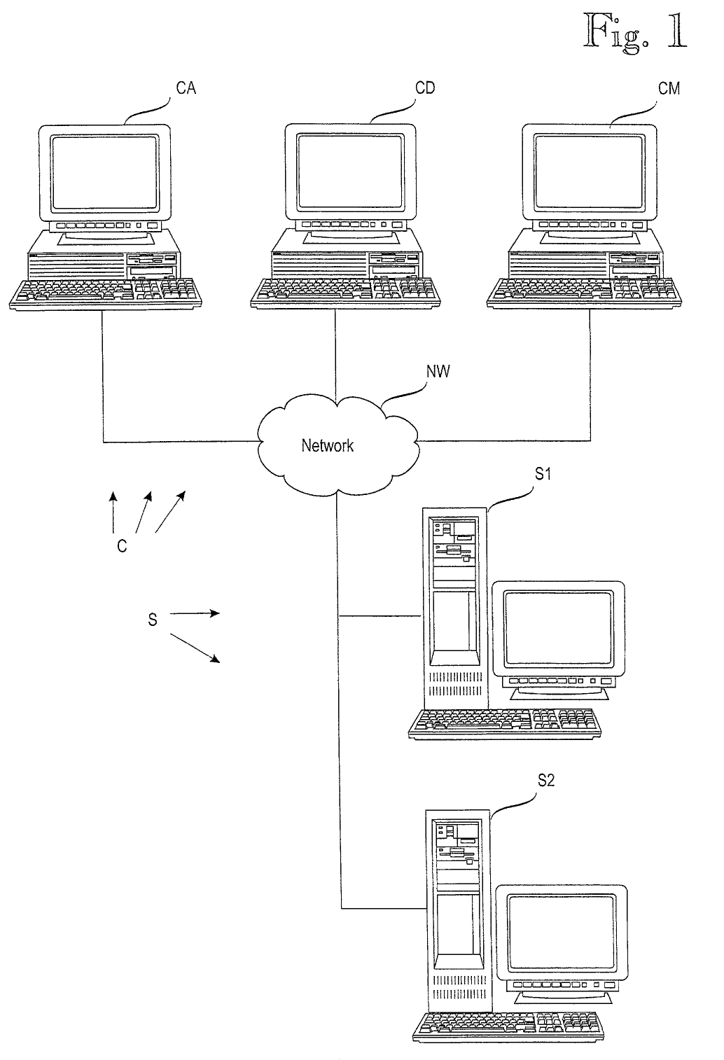

FIG. 1 is a block diagram illustrating a typical computer network topology. The arrangement shown in FIG. 1 comprises two main sections, a client site C, a server site S and a network NW connecting the sites. The client site C comprises three client terminals and the server site S comprises two server computers. However, it is immediately apparent that such distinction is purely functional. In other words, in lightly-loaded systems, all functions can be implemented as distinct software routines which are consolidated in one computer, and a heavily-loaded system may require several computers for performing the functions of each of the five computers and terminals shown in FIG. 1. It should be noted that the term ‘client’ should be interpreted in the context of client-server architecture, and the person or organization purchasing goods is called a customer.

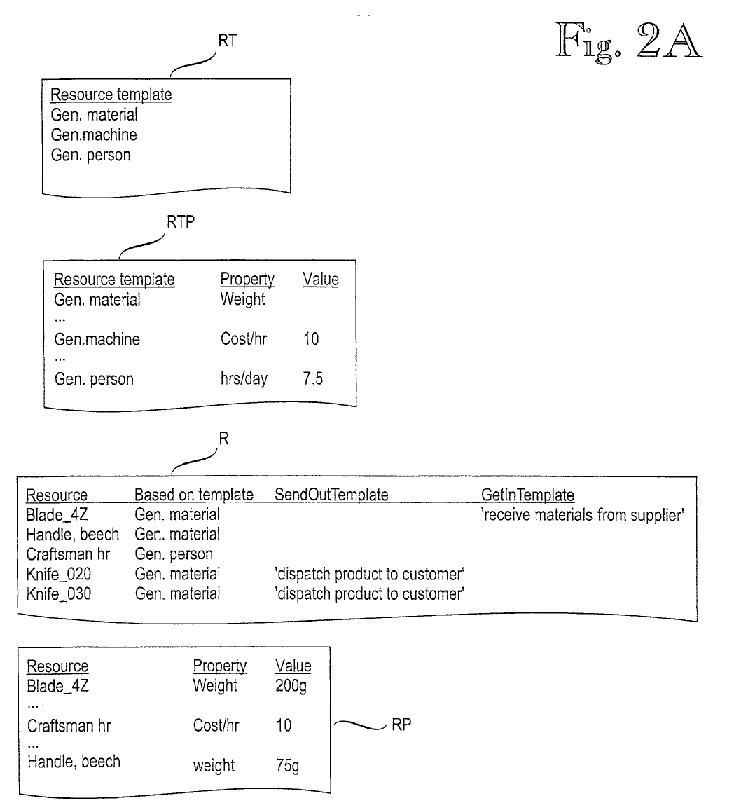

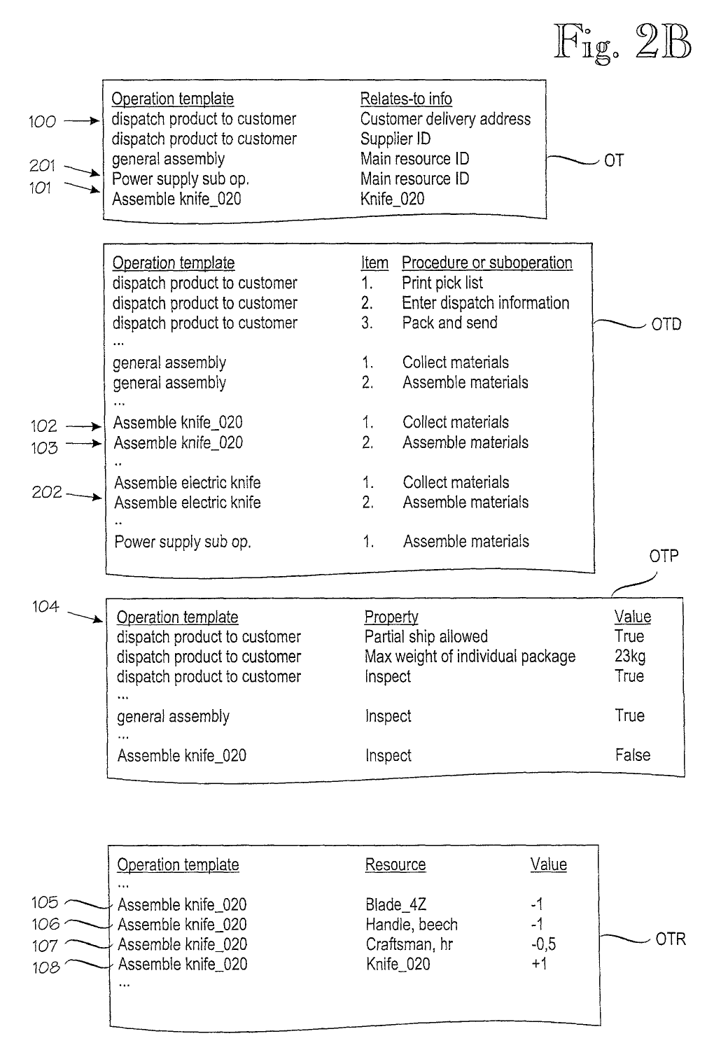

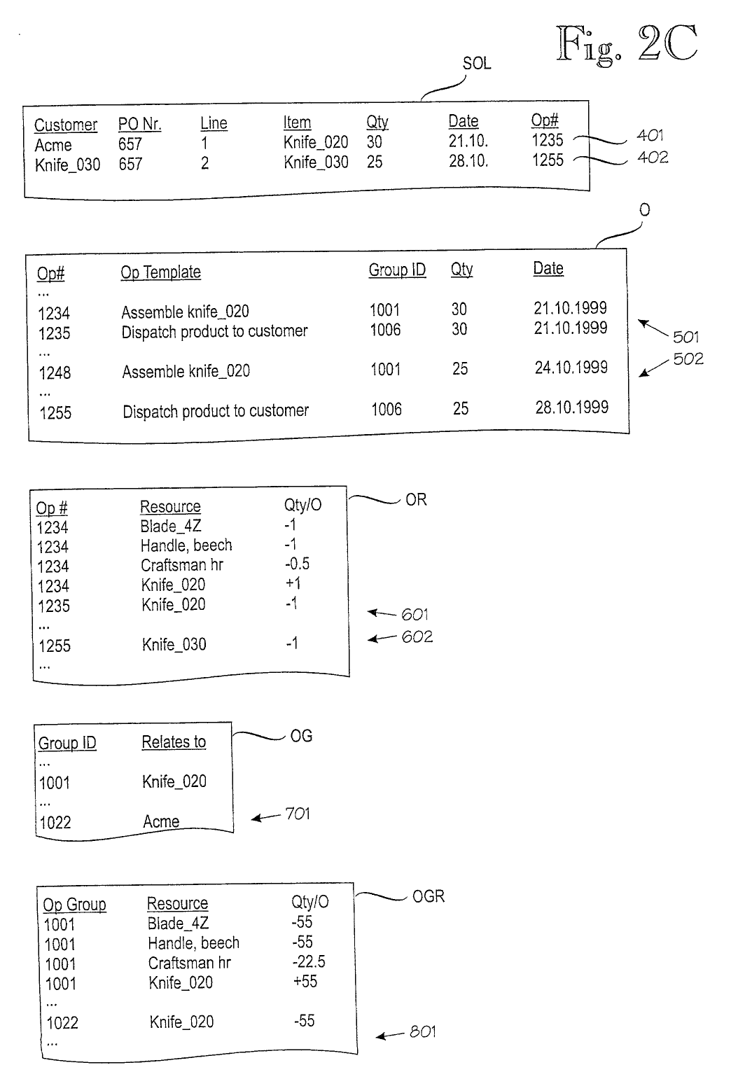

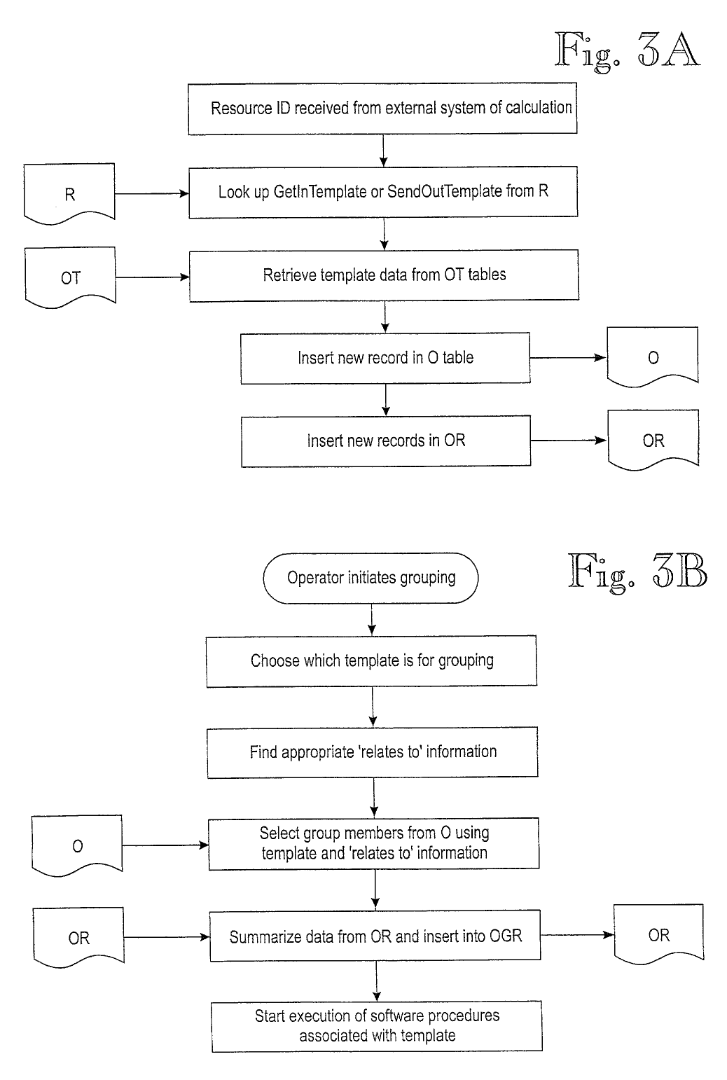

Server computer S1 comprises or executes business logic software BL, which reacts to interactions of the connected client site. Server computer S2 comprises or executes a data base management system DBMS, i.e. database tables and logic for data retrieval. The data tables illustrated in FIGS. 2A through 2C are stored on the DBMS, and they are used by the BL, based on instructions received from the client terminals CA, CD and CM. Three types of client terminals are represented: a client designer terminal CD used by a product designer, a client administrator terminal CA used by a sales and purchase order administrator, and a client manufacturing terminal CM used by an administrator for manufacturing processes. Depending on the context, the terms CD, CA and CM may refer to the terminals (the hardware), a software agent being executed by the terminals and/or a possible operator of the terminal in question, because, from the point of view of the server computers and functions, it is irrelevant whether the information is created automatically or manually.

The configuration and connection of the different systems is apparent to anyone trained in the art of setting up client/server or n-tier database software systems. As such the terms ‘list’, ‘table’ and ‘data table’ can be used interchangeably, and the terms refer to keeping data in an arranged format in the memory of a computer. The interconnection of the computers may be by any conventional networking technology. The distinction of the three client sites in the preferred embodiment is only for the purpose of clarity, and such a distinction will be typical in larger organisations. In smaller organisations the client sites may be combined in one site, but, typically, the three different functions will be present.

FIGS. 2A through 2C illustrate the various data structures (tables, lists or files) according to the invention and its preferred embodiments. The following tables will be used in this description: a resource template table RT, a resource template properties table RTP, a resource table R, a resource property table RP, an operation template table OT, an operation template procedures table OTD, an operation template property table OTP, an operation template resource table OTR, an operation table O, an operation resource table OR, an operation group table OG, and an operation group resource table OGR. To achieve more flexibility a system designer may also consider creating a table for operation group properties and operation group procedures. This would enable the client to modify the features of the operations in a group on a group by group basis. This is not essential to the functioning of the invention and is not shown in the diagrams.

In this example, the client administrator operator CA is concerned with two functions, namely entering and managing sales orders, and entering and managing purchase orders. The client designer CD is concerned with generating and updating the data in an operations template table OT and a resources template table RT. The manufacturing client CM is concerned with administrating the manufacturing functions of the organisation, including planning capacity and material requirements. This means reading, generating and analysing data from an operations table O and generating and managing operations groups using an operations group table OG.

Consider the case of a small manufacturing company that makes knives. According to the teachings of the prior art mechanism, the company would make knives according to a system having for each model of knife a parts list, showing the components of the knife, and a separate routing list, showing the manufacturing activities for the knife. Each time a sale is made, a copy of the sales order would be sent to the manufacturing site where the personnel can either manufacture the required product or supply it from stock. The sales order would be used to open a work order in the manufacturing control system, and if materials are required a purchase order would be created. Shipping, receiving and assembly have been controlled by separate processes.

A method according to the invention can be implemented as follows. The client designer CD has made a list of all types of resources either used or created in the manufacturing environment. This list includes information on machines, labour, subcontractors, and also unusual resources such as pollution permits, or even physical space. According to a preferred embodiment of the invention, such information is stored in a set of tables called resource templates RT. The characteristics of each resource template are defined in an associated resource template properties table RTP. One particular property of interest is whether the resource is can be kept in stock or not, or in other words, whether or not they are stockable. By having a stockable or non-stockable identifier information on such differing resources as materials, machine time, subcontractor services and labour may be contained in the same data tables. This simplifies considerably the system design. In general, materials are stockable, but machines and humans are not; their day's use is lost if they are not used on that day. Other properties may include weight, colour, product family, etc. If a certain property is not general to all members of the template, the property is left blank.

The client designer CD now lists all resources used or created in the manufacturing environment, and to which template each resource is related. This data is then entered to a set of tables called resource tables R. This data can be generated e.g. by copying from the appropriate template table and filling in any properties that are specific to the individual resource.

In a similar fashion, the client designer CD generates a list of all the generic operations that can occur in the manufacturing environment. This data is generated into a set of tables called operation template OT. As already stated, an operation is any discrete activity that creates, destroys, converts or requires a resource. Because they are generic, these templates may be referred to as ‘operation master templates’. However, because their data structures are the same as those of more specific templates (to be described shortly), they can be stored in the same set of tables, and the difference between a master template and an operation template is not significant. These operations templates may have properties that describe how the operation is implemented. Again, if the value of these properties is not known at this stage, they can be simply left blank. The operation template OT table contains a list of different templates. Typical operation templates may be ‘general assembly’, ‘dispatch product to customer’, ‘receive materials from supplier’, ‘receive materials from subcontractor’, etc. Each operation template may have associated with it a list of associated procedures. Data about these procedures is stored in a set of tables called operation template procedures OTD. Each operation template may have associated with it a list of resources that are created, destroyed, converted or required. Examples of procedures are given later in this document. This information is stored in a set of tables called operation template resources OTR.

The client designer CD now continues to generate operation templates that are more specific. This is continued until data for all specific operations that can occur in the manufacturing environment have been generated. Each of these specific operations is based on (and copied from) another operation template, either master or specific, giving more detailed information where required. For instance, the assembly of a specific knife, identified as ‘Assemble knife_{—}020’ record 101, is based on a template ‘general assembly’, but with the addition of the following resource information records 105 to 108: Blade_{—}4Z quantity −1 piece, Handle beech quantity −1 piece, Craftsman −0.5 hour, Knife_{—}020 +1 piece, where negative numbers denote consumption and positive numbers creation of resources. The records for procedures, 102 and 103, and properties, 104 are also created.

The client designer CD now returns to the resource tables R and marks each resource record with information indicating which operation template is to be used when the resource is to be shipped out from the company, and which operation template is to be used when the resource is required by the company. These fields are shown as ‘GetInTemplate’ and ‘SendOutTemplate’ respectively in table R. For example the resource ‘knife_{—}020’ may have a ‘SendOutTemplate’ value of ‘dispatch product to customer’ and a ‘GetInTemplate’ of ‘Assemble knife_{—}020’.

Now consider the case of the client administrator operator CA. He receives an order for 30 knives of type ‘knife_{—}020’ and 25 knives of type ‘knife_{—}030’. He enters this information into a sales order handling system. The type of sales order handling system can be quite conventional, and a typical sales order line data table, SOL, is shown in FIG. 2C. Preferably, the sales order handling system has been programmed such that, for each line of the sales order, one item (record) is entered to the operations table O. The records entered by the operator into the sales order handling system are shown as 401 and 402, and the resulting records entered into the operations table are 501 and 502. The records are created using information from the SendOutTemplate field of the R table for the knife type in question. The ‘dispatch product to customer’ template is not specific to any resource (unlike the ‘Assemble knife_{—}020’ template). So the software function that creates the operation record is programmed to create the records 601 and 602 in the operation resource table OR. These records are based on the resource information from the sales order lines. Note that the quantities in the OR table in this case are negative because the resources ‘knife_{—}020’ and ‘knife_{—}030’ are being removed from the manufacturing environment. The fields Group ID of records 501 and 502 are empty at this stage.

As is evident from tables O and OR, if there is a multitude of sales orders for an item (resource) there will be a multitude of records in the operations table and associated records in the operation resource table. Summing by date of this related information will give a profile of the requirements for each item over time.

Operations should be grouped together for more efficient processing. In a traditional system, an operator is used to ‘open a work order’ or ‘open a dispatch number’ when it is time for the manufacturing operator to start work on a certain required activity. According to the invention, the operator can be presented with a similar screen that ‘opens an order’, but behind the scenes the software is making a grouping of operations. Selection of which operations should be marked as members of the group may be made according to a set of software rules such as ‘all dispatch operations in the same week’, or the operator may be presented with a list of operations so that s/he may select the ones to be included in the group. Only operations based on the same template may be in the same group and only operations that have the same ‘relates to’ information can be in the same group. Information that should be used in the ‘relates to’ field is based on the operation template being used. Accordingly, the operator would first be presented with a screen so that s/he could choose what kind of activity should be started, i.e., which operation template should be used to create the new group. Having selected one template, the software can retrieve a group of available operations which have the same ‘relates to’ information of this operation template.

When the grouping is created, a record 701 is created in the operation group table OG. The operations 501 and 502 that have been chosen as a member of the group are marked as such by updating the group number in the field Group ID. Preferably the table operation group resource is updated with record 801 with a summary of the resources changes that occur as a result of executing the procedures in the group.

In the example of an operation template ‘dispatch product to customer’ the ‘relates to’ field of the operation group should contain the reference to the delivery address of the customer. The software can identify that the relates-to field contains customer delivery address information because record 100 in the operation template table OT specifies so. This means that all operations that use ‘dispatch product to customer’ and should be delivered to company Acme Co. with a certain address can be grouped, and so implemented together. The data that is used for the ‘relates to’ field can be stored in the operation table O, or it can be retrieved from other tables using a pointer from the operation table. For instance, the sales order line number which created the operation contains an identifier for this operation record, and from the sales order line number information the delivery address of the customer can be found.

In the example of the ‘receive materials from supplier’ template, the process would be similar but the ‘relates to’ field would be the supplier identification number.

In the example of the template ‘Assemble knife_{—}020’ the ‘relates to’ field is the resource identifier of the product that is to be manufactured, in this case ‘knife_{—}020’, so the group would consist of a number of operations based on the template ‘Assemble knife_{—}020’. In this case, the particular template would always have the same ‘relates to’ information, but this does not disrupt the workings of a method according to the invention.

Further processing is now carried out at the group level, because all members of the group are based on the same template, and, consequently, all members of the group have the same properties and procedures as set by the template. In this example, the procedures may be ‘Print picklist’, ‘Enter quantities picked’, ‘Print dispatch papers’, ‘Enter shipping costs’, etc. Each procedure should have its own software routine that completes the appropriate activities. The properties may be for instance ‘Partial shipment of order allowed’ with a value of true, or ‘Max. weight of individual package’ with a value of 23 kg. Alternatively the software procedures to administer the required activities related to the template could be associated with the template directly without reference to the OTD and OTP tables.

It is also possible to insert an operation reference instead of a procedure in the OTD table. This sub-operation would simplify the handling of the data if very complicated operation templates were envisaged. Also by using a multiplicity of sub-operations, a tree like structure can be created where operations occur inside other operations, instead of in sequence. For example, consider the case where members of a certain range of electric knives each have the same power supply. This power supply is a subassembly, which is assembled at the same time as each of the main products. The assembly of the power supply would be represented as an operation, record 201, referenced from the procedure table of the operation, record 202, for each of the main products. Thus information regarding assembly of the power supply would not have to be repeated in detail for each of the main products.

As already stated, when the CM operator sums the operation resources for the item ‘knife_{—}020’, the result is a negative number. This forms the basis for a material requirements planning system. On finding a negative number, the CM operator can return to the information in the resource table R to find the name of the template that is used for creating this resource. In this case, the template name is ‘Assemble knife_{—}020’, and this template has associated resources of Blade_{—}4Z, −1; Handle, beech, −1; Craftsman hours, −0.5; and Knife_{—}020 +1. Thus the material requirements planning system can be a simple software module that loops through the operations table O and operation resource table OR, adding records to these tables until the sums of the appropriate resources become positive.

Purchased items may have a template of ‘Receive goods from supplier’. The quantities of resources associated with this type of template are positive, indicating that resources appear from outside the system.

When such looping has created records in the O table, which are based on the template ‘Receive materials from supplier’, these records can be used as the basis for creating normal purchase orders to be sent to suppliers.

The creation of operation records by such looping routines can have different features. If it is needed to have traceability of materials through each stage of the manufacturing process, then operations would be created automatically only to give sufficient resources for the subsequent operation. However if traceability is not required then operations could be created that would give sufficient resources for the sum of the requirements of all subsequent operations in a given time period.

Although the invention has been described in connection with preferred embodiments, it is not limited to these examples, but may be varied within the scope of the appended claims.

I claim:

1. A computer-implemented method for planning and administrating the use of resources in a manufacturing process comprising a plurality of manufacturing activities;
the method comprising the steps of:
representing the manufacturing activities as operations;
receiving material- or activity-related information;
creating an operation list comprising operations, on the basis of said material- or activity-related information;
representing tangible or intangible properties which are modified by manufacturing activities as resources, wherein said modifying comprises use, creation, change and/or deletion of a resource by the corresponding activity;
quantifying said modifying by associating resource data with operations;
classifying manufacturing activities as either planned or active;
representing active manufacturing activities as operation groups; and
creating said operation groups by grouping operations in the operation list when manufacturing activities are to be changed from planned to active state.

2. A method according to claim 1, further comprising classifying each resource in the resource list as either ‘stockable’ or ‘non-stockable’.

3. A method according to claim 1, further comprising generating said operation and resource information from templates modelling generic types of operation and resource, each template being used in itself or by copies of itself to model manufacturing operations.

4. A method according to claim 2, further comprising generating an operation resource list and an operation template resource list to said operation and operation template which describes the resources which are created and consumed by the operation described in said template.

5. A method according to claim 2, further comprising generating, to said operations and templates, an operation procedure list and an operation template procedure list which describe the detailed activities needed to be carried out in order to complete the operation described by such operation or template.

6. A method according to claim 2, further comprising generating an operation property list to said template which enables the user to effect the way in which said procedures are executed.

7. A method according to claim 2, further comprising generating a resource template property list associated with said resource template list which contains information on the behaviour of each resource template.

8. A method according to claim 1, further comprising generating a resource property list associated with said resource list which contains information on the behaviour of each resource.

9. A computer program product, executable in a computer, the computer program product comprising program code means for carrying out the method steps of claim 1 when the program product is executed in the computer.
